(19) United States
(12) Patent Application Publication
(10) Pub. No.: US 2006/0178973 A1
(43) Pub. Date: Aug. 10, 2006

(54) System and method for managing business performance

(76) Inventors: Michael Chiovari, South Elgin, IL (US); Dale Pollak, Burr Ridge, IL (US)

Correspondence Address: Jeffrey A. Pine;BANIAK PINE & GANNON, Suite 1200, 150 N. Wacker Drive, Chicago, IL, 60606, US

(21) Appl. No.: 11/332,935

(22) Filed: Jan. 17, 2006

Related U.S. Application Data
(60) Provisional application No. 60/644,922, filed on Jan. 18, 2005.
(60) Provisional application No. 60/649,985, filed on Feb. 4, 2005.

(51) Int. Cl. G06Q 40/00

(52) U.S. Cl. 705/35

(57) ABSTRACT

A preferred embodiment of the invention includes a method and system to achieve improved profitability, liquidity and operational stability of a used vehicle operation. In broad overview, one embodiment of the invention includes four main aspects including the establishment of departmental objectives as a predetermined metric, the integration of the most current market and inventory information into an existing business process, the assessment of strategic impact of each key decision at a transactional level by calculating a real time performance metric and comparing the real time performance metric to the predetermined baseline or target metric and providing visibility and accountability of all key decisions.

This application claims the benefit of U.S. Provisional Application No. 60/644,922 filed Jan. 18, 2005 and U.S. Provisional Application No. 60/649,985 filed Feb. 4, 2005.

### FIELD OF THE INVENTION

The present invention relates to a novel information system and method directed to managing a business. The system has features especially adapted for use with a used vehicle business environment; although it is contemplated that alternate embodiments of the invention would be applicable to other types of businesses. Performance of various aspects of the business is measured with a system of related measures that facilitates the quantification of particular characteristics of the business. The system and method assists management in determining and monitoring department performance, assists appraisers in making accurate appraisals and assists managers/salespersons in determining how sales negotiations and decisions impact overall business objectives.

### BACKGROUND OF THE INVENTION

The pre-owned vehicle market is quite substantial. It has been estimated that there are in existence over 50,000 pre-owned vehicle locations in the U.S. when franchises and independent locations are considered. As many as 25 million vehicles are acquired and sold from these businesses. Used vehicle departments contribute significantly to dealership profitability when properly managed, and are a primary source of financial liquidity. As a result, many new vehicle dealerships consider used vehicle sales essential for maintaining the ability to conduct new vehicle sales transactions.

The key processes of used vehicle department operations include the appraisal and purchase of used vehicles for stock. Further, the maintenance of current inventory to ensure maximum gross profit and original equity is important for optimal business performance. Finally, the management of used vehicle sales transactions is necessary to ensure meeting business objectives.

The used vehicle department has a number of inherent vulnerabilities. The used vehicle marketplace is highly volatile. The wide variety of new vehicle makes and models presents a challenge even to seasoned appraisers and salespersons in obtaining current valuation information and making accurate appraisals. The widespread use of transitory new vehicle incentives causes disruptions in the marketplace. Consolidation of ownership causes separation of key stakeholders from used vehicle department decision making. There are typically multiple managers authorized to make key decisions on appraising, purchasing and selling used vehicle inventory. At any given time, not all managers will have up-to-date information or expertise. Further, the environment surrounding appraising, buying and selling is often charged with emotion, which adds another layer of complexity to decision making processes. As a result, objective assessment of a vehicle purchase or sale is made difficult and the real value of a transaction is obscured by factors other than the financial and operating objectives of the dealership.

The used vehicle department also has a number of weaknesses not addressed by present methods. For example, there is limited accountability for key decisions. Key decisions, for example, purchasing, stocking and disposition are made with individual skills, experience and judgment and often without support of empirical information. There are frequent internal and external opportunities for fraud. There exists a minimal amount of usable technology and/or business intelligence to support decision making at several levels of operation and accountability. With respect to business technology and intelligence, used vehicle operations have, to a large extent, resisted integration with electronic valuation information, for example, and have continued without the benefit of the most current supporting information and/or technology.

There is a demand for a system and method that provides relevant information in a current time frame, builds strategy awareness, and provides accountability for a used vehicle department. The present invention satisfies the demand.

### SUMMARY OF THE INVENTION

There are, in view of the above and other reasons, numerous opportunities to improve the performance of used vehicle departments. One opportunity may be accomplished by employing current technology, which makes current information available to all appropriate employees of the department. Another opportunity is accomplished by calculating, monitoring and assessing departmental strategic impact at a transactional level. Yet another opportunity is accomplished by reducing the use of individual judgments and discretion. Another opportunity is accomplished by accounting for all key used vehicle departmental purchase and sale decisions in a timely fashion or in real time.

Profitable results of a used vehicle operation depend on the successful management of three areas: vehicle acquisition; vehicle inventory and vehicle sale. Each of these areas depends heavily on the skills, experience and discretion of the key decision makers. While there is no substitute for the individual skills, experience and discretion of the key decision makers there is often a lack of current empirical information, strategy awareness, visibility and accountability for decision makers. In light of these conditions the present invention provides a method and system for key decision makers to improve performance in each of the three above areas. This is accomplished by creating a novel method and system for the acquisition, inventory and disposition of used vehicles. The following briefly describes the method and system for improvement in each area.

These and other objects of the invention are provided, in one embodiment, by a method and system to achieve improved profitability, liquidity and operational stability. In broad overview, another embodiment of the invention includes four main aspects including the establishment of departmental objectives as a predetermined metric, the integration of the most current market and inventory information into an existing business process, the assessment of strategic impact of each key decision at a transactional level by calculating a real time performance metric and comparing the real time performance metric to the predetermined baseline or target metric and providing visibility and accountability of all key decisions.

Another embodiment of the invention includes eight main aspects including: the establishment of departmental objectives as a predetermined metric; the physical and or virtual inspection of a vehicle; the integration of the most current market, inventory, past sales, and co-appraiser evaluation information into the existing business appraisal process; the assessment of strategic impact of each acquisition decision at a transactional level by calculating real time performance metrics and comparing the real time performance metrics to the predetermined baseline or target metrics; providing accountability and visibility through the creation and maintenance of a permanent appraisal record at both a transaction and individual appraisal level; providing accountability and visibility through the creation and maintenance of a dynamic inventory record; the assessment of strategic impact of each disposition decision at a transactional or aggregate level by calculating real time performance metrics and comparing the real time performance metrics to the predetermined baseline or target metrics; and providing accountability and visibility through the creation and maintenance of a permanent sales record at either a transaction or aggregate level.

### BRIEF DESCRIPTION OF THE DRAWINGS

While the claims concluding the specification particularly point out and distinctly claim the precise subject matter regarded as the sum and substance of the present invention, its construction and composition may be best understood from the following detailed description taken in connection with the accompanying drawings, in which:

FIG. 1 shows a system according to one embodiment of the present invention; and

FIGS. 2-6 show one embodiment of a preferred method according to the present invention.

### DETAILED DESCRIPTION OF A PRESENTLY PREFERRED EMBODIMENT

The System

The system 15 includes software applications and associated hardware through which the present invention is implemented. In its most general form, the hardware includes one or more application server or application server system 20. The application server system 20 is connected so as to communicate through a network 30, in a hard wired and/or wireless fashion, to a plurality of client nodes 40. Each client node 40 may comprise a dealer or client computing device 50, such as a desktop computer or server. Each client computing device 50 is itself connected, in a hard wired and/or wireless fashion, to a plurality of user electronic communication devices 60, 70, 90 to communicate therewith. Communication devices 60, for example, a tablet computer, a digital camera, and so on, may be directly connected to the dealer computing device 50. Communication devices 70 may be a wireless computer, tablet computer, PDA and so on which communicates with the node 40 and/or server 20 via the network 30. Communication device 90 may be a wireless computer, tablet computer, wireless PDA, cellular phone or PDA which communicates with the node 40 and/or server 20 through a wireless node 80 capable of receiving and transmitting information according to a standard wireless protocol. In alternate embodiments, the user electronic communication devices communicate directly or indirectly with the application server system. It will be understood that the system 15 of the present invention will operate with well known software and protocols as will be detailed below.

The Operation

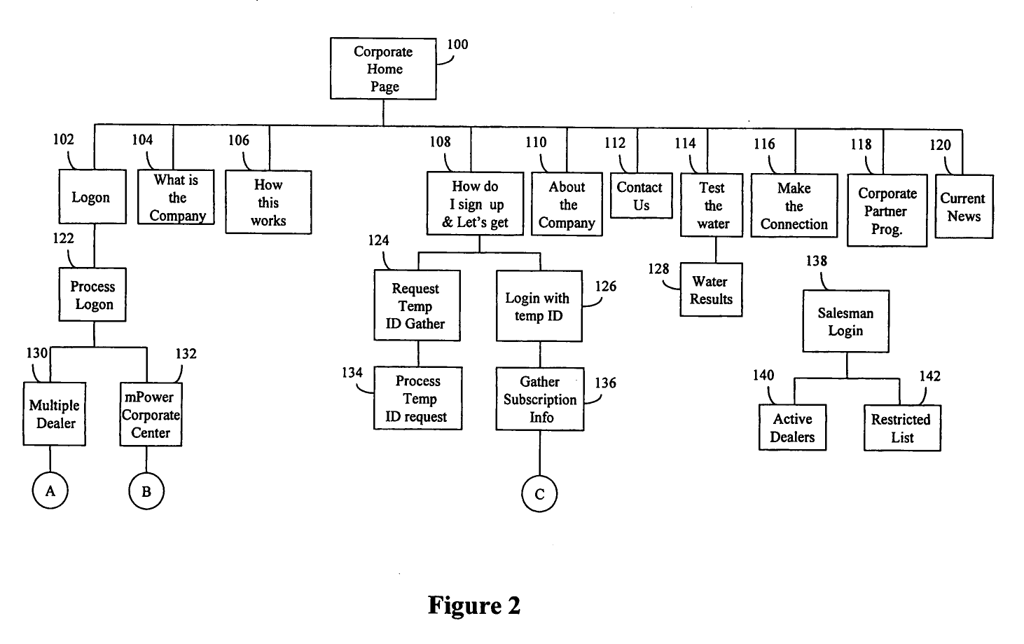

A preferred method and system according to the present invention is shown in FIGS. 2-6 in an organizational flow chart. While the invention is advantageously implemented in an internet (via TCP/IP, etc.), web-enabled, cellular and WAP environment with mostly known hardware, software and protocols used therewith, it is contemplated that other systems may be employed which perform the same functions and/or accomplish the same objectives. Also, while it will be understood that the present invention is particularly well suited to previously owned vehicle dealerships and business environments, and the illustrative examples given will be directed to a system and methods for previously owned vehicle business applications, the invention may be suited to other business models as well, and thus, should not be limited by the examples provided. Furthermore, the following description is set out in block form where each block may represent a website page or a set of related functions of the system or steps of the method of the present invention. Of course each website page or function will be supported or otherwise enabled by associated software and hardware. In some cases, this software and hardware is well known, such as, for example, conventional operating systems for the application server system or wireless application protocol, and so on. In other cases, calculations and/or operations will be performed by novel aspects of the system according to the invention.

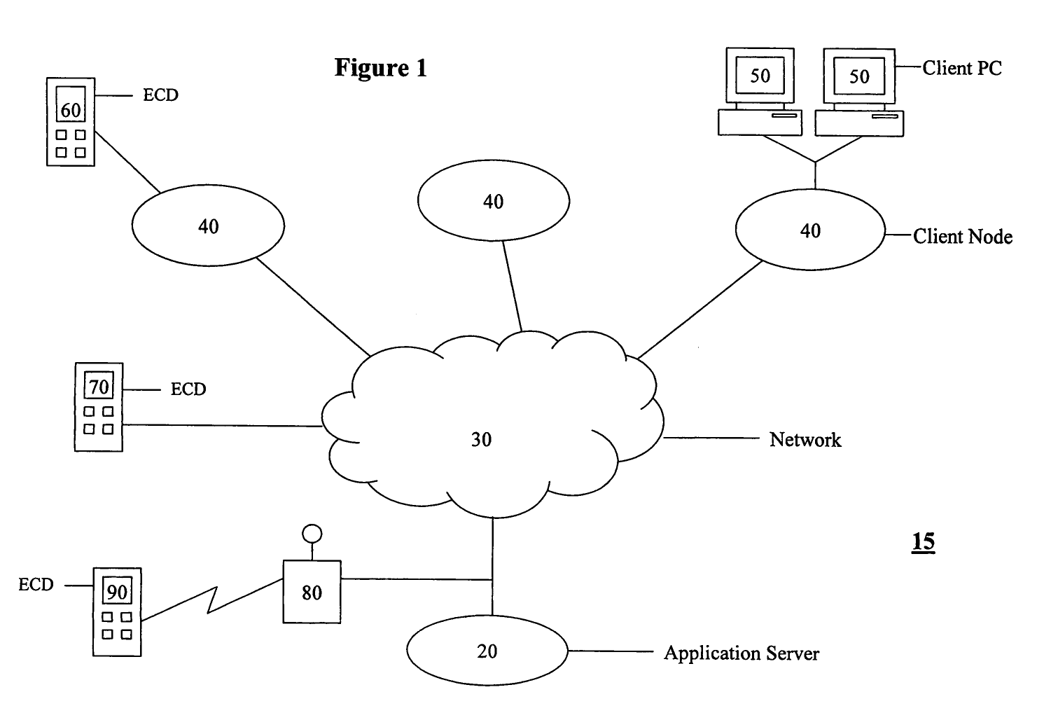

Referring to FIG. 2, a user (collectively described below) may access and/or initiate the system and method of the present invention by accessing a website home page at block 100, preferably hosted by or operated through application server 20 (See FIG. 1). It should be understood that some users will access the site in other insertion or access points of the system according to the users function. The system and website is set up and may be operated through the application server and maintained by an owner and/or operator of the system (hereinafter collectively referred to as the “company”). For example, the user may be employed or otherwise associated with the company or in the alternate, a client of the company, for example, owners or employees of a used vehicle dealership and further may be an associate externally related to the company or dealership. Of course, the user may be a prospective associate or prospective client of the company.

The user may be but not limited to a company or client salesperson, an external wholesaler, a client manager non-appraiser, a client manager appraiser, enterprise personnel, company systems personnel, a business owner, a business manager, a super user (one with unlimited access to the system), for example. Numerous links are provided on the home page 100 including links to a login field or fields (block 102), a page for viewing information (block 104) related to the system, an explanation of various operational processes (block 106) of the system, an explanation of how to subscribe and/or become a client (block 108) to use the system, company facts (block 110), a company contact provision (block 112), a utility to do a calculation directed to determining water (block 114), “Make the Connection” (block 116), notices regarding a partner program, e.g., sales training, auction operations, etc., (block 118), and a current news page (block 120), each of which will be explained more fully-below. It will be understood that the blocks 102-120 may be links accessible from home page 100 and are executable through conventional HTML and other protocol.

From the home page (block 100), a user may access various system functions through a login screen (block 102). The login screen (block 102) is accessible through a variety of electronic communication devices (20, 40, 50, 70 and 90), including desktop and portable computers 50, cellular phones 90, personal digital assistants 70 (PDA), and the like. Depending upon the electronic communication device, the system 15 accommodates the data transfer rates and protocols, by for example providing a high speed, full bandwidth data connection with a desktop computer 50, or providing a tailored subset of data in a protocol appropriate for the device, by a wireless application protocol (WAP), SMS messaging, SMTP, or other standard protocol or interface.

Login procedures are conventional and include the option of submitting a request to add a user. The system 15 may automatically assign each new user an identification name or identifier (ID) and a default password. The user, once validated, is provided an opportunity to change the password. In the alternate, the system will accept a valid e-mail and a user-provided password. There is a provision wherein a system administrator or authorized person employed by the client may add and delete users. Preferably, user IDs and passwords are adaptable for use with PDA, wireless and other cellular devices, i.e., they are short. The user may submit a request to add another user. The vehicle dealer system administrator or an authorized person is permitted to add and delete users.

Desktop users may access the “What is the System,” block 104, which includes information related to the company. The page, block 104, may include, for example, a streaming video with a high level description of the system and corporate information. For example, the video may be two to three minutes long. It is preferable that the video is constrained from being run on anything other than a desktop high-speed connection. A link may be provided to permit downloading of an appropriate media player or plug-in for playing the video. Other marketing material may be provided and/or accessed via the page corresponding to block 104.

A page, block 106, is accessible from the home page 100, which is directed to describing how the system and process works. Users are given an opportunity to view a streaming video, computerized slide presentation, or the like, which gives a thorough presentation of the company and product. This video is longer than that previously discussed, and may be for example, 15 to 20 minutes long. The presentation will preferably be utilized by sales personnel of the company who are showing the system to clients and potential clients. Pre-owned vehicle dealers, i.e., clients and potential clients, will be able to view, pause, rewind and replay the video. The video or other media presentation will describe the metrics used by the system and method of the present invention to measure, track and report various performance measurements and how it relates to and may be used to enhance dealer profitability. Preferably, the media presentation is only accessed through a device with a relatively high speed communication connection. Downloading of a free player or plug-in to view the video is provided.

This page (block 108) describes the sign up or engagement process and preferably provides a high-level graphical workflow diagram to show the steps necessary for potential clients to sign up or become engaged with the company. Preferably, the diagram is simple, yet as clear as possible, so that a potential client may know what to expect through the sign up process.

Block 110 is an informational page that includes biographical and other information regarding the corporate owners and officers. In one embodiment, a mission statement may be provided as well as links to employment opportunities and so on within the company.

Block 112 is a page that includes relevant corporate addresses and contact information and preferably includes e-mail addresses so that users, clients and prospective users and clients may easily contact the company.

Block 114 is a page that provides a utility with which a dealer may calculate an amount of water (see detail below) for individual vehicles. Initially, a user is provided the opportunity to enter dealer contact information. The system allows potential system buyers to enter up to 10 vehicles, for example, preferably by using conventional drop-down boxes with fields for year, make, model and vehicle condition along with investment amounts for each vehicle. A provision or field may be provided in which a user may enter a vehicle identification number which then decodes particulars of the vehicle according to year, make and model. The user may also enter a regional code, for example, by state or county. A user may next select from a list of guide resources for example, Kelly blue book, black book, NADA, auction values, Galves and so on. Upon completion of the previous steps the user may click a test button and the system will compute the amount of water for each vehicle.

This page (block 116) describes how one goes about connecting to the system. As explained above, the connection can be made through a number of electronic communication devices including a desktop computer, a PDA and a cell phone. Provision may be made for testing a cell phone, for example. The user may enter a current activated cell phone number in a field on the web page. Identification of an appropriate service provider is given. The user may then click a test button provided on the page. The system sends a test text message to the cell phone, and may include a text message for example, that a car is waiting to be appraised in the east lot. Notification may be displayed regarding a nominal fee to be charged for the test message.

This page (block 118) provides description of and guidelines for partner programs. Links may be provided to partner sites. Partner programs provide the opportunity to associate or work with the company, for example, with respect to sales and system training companies, vehicle auction companies, and so on.

The current news page (block 120) is accessible through a desktop computer or the like. This page is provided to list and describe current events related to the system, operating procedures, the used vehicle industry, and other related news.

This page (block 122) includes associated executable software that determines which homepage to render for the user upon login, and may be accessed through a conventional personal computer 50 or an electronic communication device 70, 90. The users will include, for example, dealership personnel with scoreboard access (see blocks 146, 148), dealership sales personnel (customer center, see block 144), external wholesalers (wholesale center, see block 150, 194), and corporate personnel (corporate center, see block 132).

This page (block 124) processes requests for temporary identification number from block 108. Users without a login identification number will enter key dealership information. They may be e-mailed a temporary user identification number or similar identifier and temporary password. A field is provided that permits the user to enter a salesperson code. An alternate code may be entered if a prior code has never been assigned, for example, if a dealership begins subscribing to and using the system without first contacting a company salesperson. If a salesperson code is entered, the requesting dealership is automatically assigned as an active dealer to that specific company salesperson. As noted above, the page may receive a valid e-mail and user-supplied password.

A user may login with the temporary identification assigned by the system to gain access to an application to calculate the cost of signing up as a subscriber of the company and have the option to proceed to completely sign up for the system online (block 126). In a preferred embodiment, the temporary identification expires after a predetermined period of time, for example 60 days. Company employees can extend identification numbers if requested through the company center.

This page displays the results of the water calculation (block 128). This page shows amount of water calculated from data related to the vehicle specified by the user in block 114. As described herein, water is computed by subtracting the current market value from an amount of the original investment plus any additional costs, e.g., reconditioning costs.

A separate login page is provided (block 138) for the company salesman where it is possible to directly view an active dealer list (block 140), and dealers the salesman should not contact, i.e., a restricted list (block 142).

Management applications are provided (block 130) accessible from block 122, for addressing clients which have multiple locations or dealers (collectively known as enterprise dealers). A list is provided of all the dealers or locations and allows users to indicate which one or which ones he/she would like to work with. This feature may be accessed through the corporate center enterprise or multiple dealer setups.

Block 132, accessible through block 122, provides access to the system, which access is restricted only to company personnel, for maintenance and other functions. This page (block 134) is accessed through block 124, and includes applications for processing temporary ID requests. When a request is received from a potential client, information received from that potential client is recorded in a database. The server 20 of system 15 assigns temporary identification which may be a number or alphanumeric and a password is e-mailed to the requester.

Provisions in block 136, accessible through block 126, are made for the inputting of subscription information for clients first setting up the system for use with a dealership or the like. Users enter the valuation guides they would like to use. Examples of the valuation guides include black book, Kelly blue book, NADA, Galves, and auction guides. Users typically enter a number of expected appraisers to be accessed by the system.

This page includes provisions to manage active dealers (block 140) from the company salesperson login (block 138). Salespersons and others of the company can view a list of dealers actively using the system. Provisions are included to extend dealer temporary identifications and passwords. The setup status of dealers may be viewed. Detailed dealer information may be viewed for various purposes, including contacting that dealer. Dealers may be assigned to a company salesperson either automatically or through the company center. Block 142 includes a restricted list. A restricted list will include any dealer to sign up for the system program or includes or has an active temporary identification and password. Also provided is a list of dealers that company sales personnel of the company should not contact. The list will be provided without changes regardless of which company salesperson logs into this page.

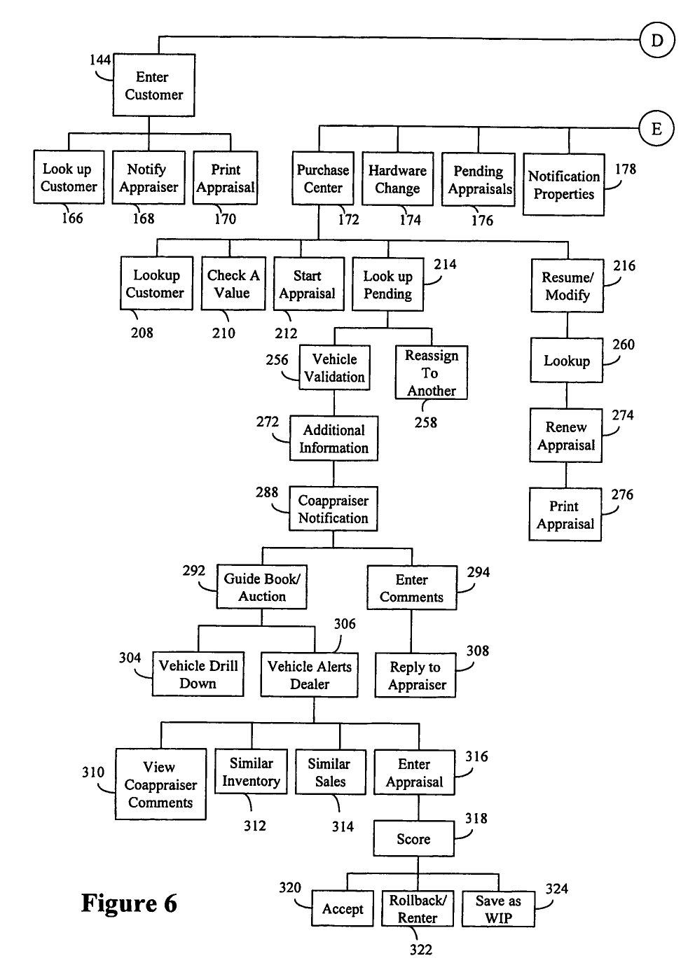

Turning to FIG. 6, this screen (block 144) is accessible by dealership sales personnel through the login process, blocks 102, 122. On this screen, provisions are made for a dealer salesperson (client) to enter standard customer information, such as address, name, telephone number, Social Security number, drivers license information, and so on. The dealer salesperson may also enter vehicle information, such as vehicle identification number, mileage, color, location, and license plate number. The vehicle identification number may additionally be decoded by the system 15 to determine the year make and model of the vehicle.

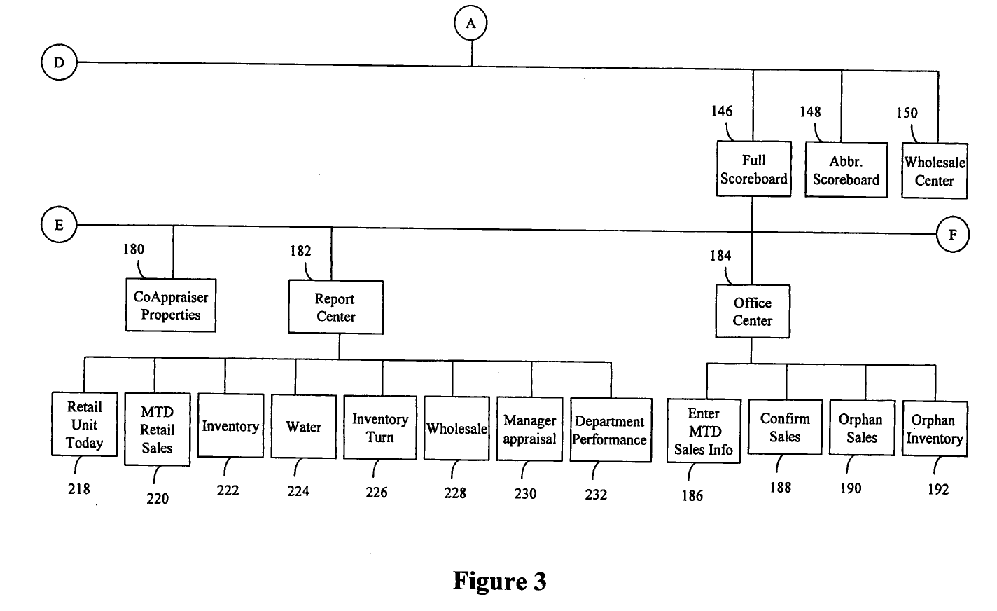

Turning to FIG. 3, this page (block 146) (Scoreboard) is a default login page for most dealership personnel, especially managers and owners, and is also accessible through the login process, blocks 102, 122. This page displays current and month to date information with progressive links to show supporting detail. Higher level information is found within the report center (see block 182). This page represents functionality which may hereinafter be referred to as a “Full Scoreboard”. Inventory and performance scores (metrics), sales numbers, retail/wholesale breakdowns, average and other inventory turn, year/make/model data is displayed on the “Full scoreboard” for example.

This level (block 148) is designed to be very simple and provide for access with a hand-held device such as a cellular telephone or other cellular communication device. The application provides the same basic functionality as the Full Scoreboard (block 146) but in a simplified format.

This page (block 150) is designed to be accessed by two types of users. The first user is a vehicle dealership. The second user is an external wholesaler. Dealership personnel can perform a set of functions within the wholesale center while external wholesalers can perform another set of functions. External wholesalers will be sent directly to this page when they login. The dealership functions include adding new wholesalers and communicating with the wholesaler. The wholesaler functions include accessing pending appraisals, maintaining data about the wholesaler operation and hardware setups for both sets of parties. Essentially, this permits manager/appraiser/wholesaler transactions, (these functions are shared with block 194).

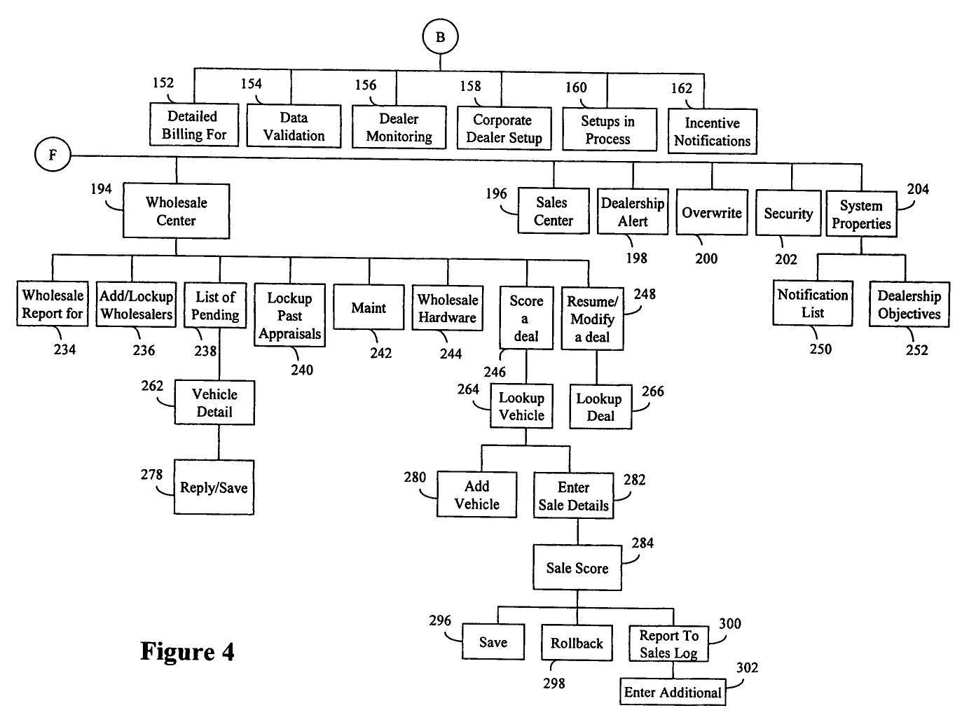

FIG. 4, which continues from FIG. 2, block 132, represents a page, block 152, which permits detailed billing of vehicle dealers by the company. This page includes applications for generating monthly bills to be sent to the client dealer and applications for sending the bill to the client dealer by way of e-mail. An online payment service is also contemplated or any other suitable payment arrangement. There is a provision to resend previous bills. Also included in the list of billable users are other clients, for example independent appraisers. One option of billing includes automatic charges to a credit card or other electronically accessible accounts.

This page is a data validation page (block 154). A utility verifies that expected data has been received from outside sources. The utility verifies that data is current or has been refreshed. Additional information is provided by outside sources including data derived from a dealer management system (hereinafter referred to as a DMS), decoded data from the vehicle identification number, data derived from auction sources, black book, Kelly blue book, Galves, and NADA, for example. An important feature of the system and method of the present invention includes an additional source of information to be factored in, namely manufacturer incentive data.

This page includes a dealer monitoring utility (block 156). This utility tracks dealer usage or lack of usage of the system. A report may be generated for any dealer that does not login or is missing information. This report is used by the company in order to be proactive in assisting dealers to use the system, for example. This page may include a utility which provides for monitoring closely that dealer month-to-date information is being entered and initial orphan inventory (see below) is being accounted for. The system watches that month-to-date sales figures are being entered. This is an important feature because the month-to-date sales figures are needed to compute the omega (described below) on incoming vehicles.

This page, (block 158) is utilized by the company to setup dealers with multiple locations (enterprise dealerships). Many organizations selling pre-owned vehicles have multiple locations. This screen allows the company personnel to setup links between them so that data may be shared, sales person personnel may work in multiple locations, and so dealer and company personnel can both access these multiple stores through multiple dealer screen (block 130). The purpose of this page and the page functionality is to provide clients with multiple locations access to multiple stores with a single login identification and password.

This page (block 160) lists dealers with active identification numbers and passwords that have not completed the process to setup a dealership or client account. The list may be sorted by company salesman. It is possible to view in which part of the setup the process was halted. It is possible to view the number of days left in which the password is valid. Other information is viewed from this page including detailed dealer information and contact information. The ability is provided to extend a number of days that the password is valid. A company salesman may be assigned to further the setup process.

This page (block 162) includes notifications regarding incentives. Incentive data is updated either from a data feed or manually. Incentives may be classified as either customer incentives or dealer incentives. Accordingly, when appraising a car, the system notifies the appraiser of current incentives applied toward a new car of the same type. This is necessary for accurate appraisal because it typically takes time for the valuation guides information to catch up with valuation guides when incentives are first offered by manufacturers. Typical evaluation guides adjusts to incentive notifications in about fourteen days.

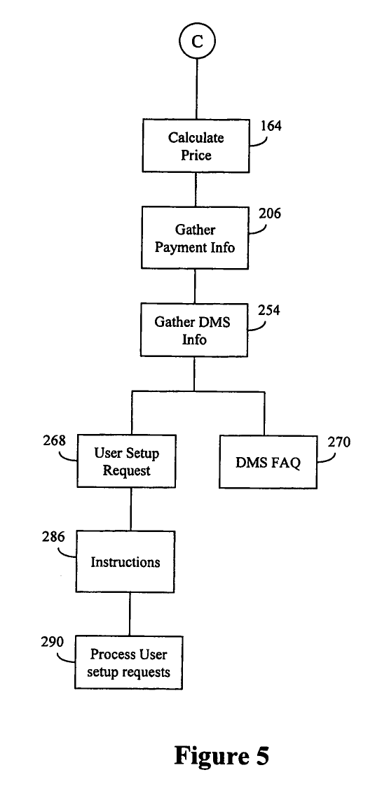

Turning to FIG. 5, which continues from block 136, in this web page, block 164, clients and potential clients may detail the base price and alternate prices for use of the system 15 of the present invention. In one embodiment, the cost of use of the system may be based, at least in part, on the number of appraisers. The price may be provided as a total and further broken down according to options and the number of users. Potential clients and users may recalculate a price and/or a subscription by altering options and/or the number of appraisers and/or the number of users. Preferably, users are advised that during setup of the system, an option to change the number of appraisers during a more detailed setup process is provided and then a final price is calculated and displayed.

Returning to FIG. 6, this page, in block 166, allows a company user, for example a company salesperson, for example, to search, sort and display active clients/customers. An active customer is a client that has been entered into the system and approved within a predetermined number of days, for example 60 days.

This page, block 168 includes functionality such that after entering customer and vehicle information, a dealership user, for example, a dealership salesperson may select from a drop down list, or an equivalent thereof, an appraiser. The appraiser may be notified on an electronic communication device 60, 70, 90 (see FIG. 1), that a vehicle is ready for appraisal. A location of the vehicle is given as part of the notification.

One part of used vehicle dealership practice is producing a printed appraisal. The printed appraisal is generated along with an optional electronic record of the appraisal (block 170). A salesperson is allowed to print or reprint the appraisal as long as it is current. In the event that an appraisal is old (past a predetermined period of time or other predetermined threshold), the system can be configured such that only a manager can renew it, which allows the appraisal to be reprinted.

This is the initial page (block 172) for beginning the appraisal process. Access to this page is limited to users that are current subscribing clients.

This page (block 174) allows users to change specific hardware information. For example, a change of a cell phone number, carriers or equipment is made possible by entering information as appropriate.

When asked to appraise a vehicle, a person is assigned to be either a primary appraiser or a co-appraiser. This screen (block 176) lists vehicles in a queue for appraiser input and states whether the appraiser is a primary appraiser or a co-appraiser.

Users may set up individual criteria or thresholds (block 178) to provide a notification when specified events reach predetermined levels. For example, users may set up a month-to-date performance score (described below) or when a predetermined omega (also described more fully below) is reached.

Returning to FIG. 3, block 180 represents a page wherein specified managers or persons are provided the ability to assign additional people as receiving notification when a particular person is making an appraisal.

An organizational hub is provided in block 182 to retrieve detailed information from a Scoreboard, (block 146, 148). Users are provided the ability to go directly to the desired report.

Block 184, hereinafter referred to as the “Office Center” is a restricted access page that allows predetermined users the ability to link to pages and perform a variety of functions. The functions include the ability to enter month-to-date sales information (block 186), confirm a sales log (block 188), orphan sales (block 190), and orphan inventory (block 192) each of which is discussed below.

Returning to FIG. 4, block 194 (identical page as that in block 150, which the same functionality) the “Wholesale Center” is accessible to two types of users. A first user is a dealership and a second user is an external wholesaler. The dealership personnel can perform a specified set of functions within the wholesale center while external wholesalers can perform another set of specified functions. External wholesalers are sent directly to this page.

Block 196, hereinafter referred to as the “Sales Center” allows users the ability to enter a sales transaction either through retail or wholesale channels into the system.

Block 198 is provided to setting up dealership alerts. This page allows a dealership to enter alerts for either sale of a particular vehicle or for the purchase of vehicles.

Access to this screen (block 200) is restricted to higher level dealership managers or the like. This screen allows a user to modify or overwrite information, for example, the current market value of a vehicle. The user may enter a difference between the appraised value (positive or negative) and the current market value.

Block 202 permits assignment of entitlements to the various screens for the various users. A user may request additional user identification numbers be assigned to the system. Users may also be deleted from the system.

Block 204 is preferably accessed when a client performs an initial set up of the system for use. Users are prompted to specify dealership objectives and notification lists.

From block 164, a user turns to block 206 (FIG. 5) to gather payment information. Dealerships and other users signing up to use the system enter credit card or other financial information on this screen. The site, of course, is secured from intrusion or hijacking by outsiders. The terms and conditions of contracting with the company may be displayed on this page. Additional functionality is provided to accommodate non-credit card setup.

This page (block 208, FIG. 6), accessible through block 172, includes a provision by which a user with proper security access may look up customers. For example, an active customer is a client of the company that has had a vehicle appraised within the last 60 days.

This page (block 210), accessible through the Purchase Center in block 172, allows a person with appraisal rights to quickly check a value on a vehicle without requiring it to be associated with a customer. If desired, a full appraisal may be initiated and customer information may be entered.

An appraiser may initiate an appraisal, if desired in block 212, accessible through the Purchase Center in block 172. By starting at this screen, an appraiser may proceed to the “Enter Customer” screen (block 144) which permits an appraiser to continue the appraisal process.

Once an appraiser is notified that a vehicle is ready to be appraised, this screen (block 214), accessible through the Purchase Center in block 172, lists all appraisals that are queued and waiting to be appraised. The appraiser may either continue with the appraisal or assign it to another appraiser.

This screen in block 216, accessible through the Purchase Center in block 172, allows the appraiser to return to the previous screen, and continue or modify an appraisal. Thus, appraisers are allowed to modify appraisals performed by others. However, the person that performs the modification preferably takes responsibility of the appraisal. Any modification of an existing appraisal may restart the time period, which defines how long an appraisal is current or acceptable to the dealer. Once entered into the DMS, appraisals can no longer be modified.

Returning to FIG. 3, block 218 provides, a page accessible through the Report Center in block 182, a listing of all of the vehicles reported to the “sold log” on a particular day. Preferably, the log includes a vehicle description; the responsible salesperson; whether a trade, finance, or spot deliver, and also the performance score and omega metric associated with the sale (discussed below) and other information e.g., date of transaction.

Block 220, a page accessible through the Report Center in block 182, provides a report on the confirmed transactions from the dealership office if the dealership is using this functionality. Month-to-date retail sales counts are preferably entered manually by dealership office personnel along with gross profit or imported from the DMS. This information is important as it is used in performing metric calculations, which will be explained in detail below.

Block 222, a page accessible through the Report Center in block 182, provides a detailed report showing the vehicles in inventory. Users are able to click on a vehicle to receive additional information about a vehicle. For example, the person responsible for taking in the vehicle will be listed and a current market value will be listed based on the date the vehicle was brought in to the dealership. Each vehicle will have associated therewith an inventory score (described below) based on the current market value and the investment amount. The system may show exceptions when the system investment amount is less than DMS investment amount on a first day in inventory. Functionality of this page may be provided in conjunction with conventional inventory software.

Water is defined as the difference between the investment amount and the current market value plus other associated costs. Block 224, a page accessible through the Report Center in block 182, provides a report detailing the water in a particular dealership inventory. The report may also provide a graphical trend showing the water on a month-by-month basis for the entire dealership portfolio (inventory) from the beginning of working within the system of the invention. Other financial or metric calculations may be made and displayed, such as the average dollar depreciation at a unit level.

A worksheet is provided in block 226, a page accessible through the Report Center in block 182, allowing a dealership to see how changing certain variables can affect inventory turn. This page, block 228, a page accessible through the Report Center in block 182, shows detail confirmed wholesale transactions should a dealer use this functionality or may show month-to-date information that has been entered by the dealership back office or any administrative personnel required for the omega calculation/scoring.

Depending on how security is set up, block 230, a page accessible through the Report Center in block 182, shows either individual manager appraisal information or all of the manager information. Manager information may include name; number of appraisals; average score today; average score month-to-date; omega impact today; and omega impact month-to-date. A user is able to click on one of these numbers to see the detailed data.

Block 232, a page accessible through the Report Center in block 182, gives a vehicle dealer an indication of trends since subscribing and since the initial application of the system and method of the present invention. It can show average gross profit per unit, water percent and dollars at inception and currently.

Block 186, which is accessible through the Office Center at block 184, requires entry of month-to-date sales information, which is a required process to be performed by the dealership at least once a month or automated through the DMS. The system should send out reminders to dealers that have not entered this information. The company receives a report from the system of dealers that have not completed this step.

This page, at block 188, which is accessible through the Office Center at block 184, confirms sales log transactions. Should a dealer decide to use this screen, back office person or dealership administrative personnel can confirm the gross profit that a sales manager has entered and make necessary adjustments. In the alternate, this may be performed automatically through the DMS. There are preferably four levels of possible confirmation: a sales manager entering all information; a sales manager entering only gross profit; an office person can enter information either detail or just gross; and an office person can enter month-to-date information. An office person can overwrite (i.e., correct) information. The ability is provided to view a detail screen associated with the deal. Gross profits seldom match from the showroom to the back office, in which case, it is preferable to provide a comment section to explain any differences. This information is combined with the information to be confirmed in block 192.

Block 190, which is accessible through the Office Center at block 184, allows (Orphan Sales) sales that have been picked up from the DMS feed that have not gone through the system and allows a user to assign a manager (or use a default) and enter a gross profit amount. Orphan inventory refers to vehicles that have been picked up by the DMS that were not entered into the system (including initial inventory). Users, in block 192, accessible through the Office Center at block 184, enter minimally the condition of the vehicle. The system permits close monitoring of this list.

Returning to FIG. 4, block 234, which is accessible through the Wholesale Center in block 194, allows dealers to display and/or print wholesale information gathered by the system and is able to print for a date range and/or by wholesaler. This feature is available only to dealers. Blocks 234-248 are accessible through the Wholesale Center in block 194.

This page, in block 236 refers to a feature that is only available to dealers. A dealership can either add a wholesaler to the Wholesale Center or lookup a wholesaler to add them to their notification lists. This page, in block 238 is a feature available only to someone designated as an external wholesaler and allows the external wholesaler to lookup their pending appraisals. Appraisals will only remain in their pending list until either they give their response or 24 hours.

An appraiser is permitted, in block 240, to lookup past appraisals they have done and may only view their own appraisals. Vehicle information is shown along with appraisal. Appraisals that were dropped from pending either by crossing a time threshold or lacking a response will preferably not be displayed. The user will be able to sort (select) by dealership. Preferably, only year, make, & model is displayed and not the vehicle identification number.

Block 242 provides the ability for wholesalers to remove themselves from a dealer contact list. Short comments can be added and any notification is sent to relevant dealership regarding the change. Wholesalers, in block 244 are allowed to change specific hardware information such as cell phone number or carriers. The process of scoring a sales transaction may be initiated in block 246 should a dealership decide to use this function.

Users may return to a sales deal in block 248 and make modifications to details entered until the vehicle has been confirmed by the back office of the dealership or the vehicle has been reported sold through the DMS. If changes are made, the changes will be reflected in the scoreboard detail.

This page, block 250, which is accessible through block 204, permits the setting up of all of the possible people that can be notified, and further may be either internal dealership personnel or external wholesalers. The user is able to select from a drop down menu (or added through the Wholesale Center, block 194). Users are allowed in block 252, which is accessible through block 204, to enter key dealership information that is used by the system, including: target used vehicle inventory; target average gross profit per unit (retail); target average gross profit per unit (wholesale); standard markup; number of retail units for last 12 months; number of wholesale units for last 12 months; target average unit age; and maximum acceptable water.

This page (FIG. 5) in block 254, accessible through block 206, provides for the entering of key information to gain read only access to their DMS system. Preferably, the data required will be a dial in number; User ID; and Password or the like.

An appraiser (FIG. 6) in block 256, which is accessed through block 214, is provided a display of information entered by the salesman and is permitted to validate the information. Key items such as mileage may be confirmed. An appraiser, in block 258, can reassign a pending appraisal to another appraiser. This will begin a notification process for the new appraiser. An appraiser can reassign an appraisal to themselves which should send a cancellation message to the original appraiser. This page, block 260, allows users to search for and display appraisals. Appraisals will preferably only stay active for a certain predetermined period or until brought into the inventory through DMS.

On this page, in block 262 (FIG. 4), vehicle details may be displayed and accessed by external wholesalers. The display should not include black book or auction information from the system or the VIN number. Users may search in block 264 for a vehicle in inventory based on stock number, VIN or just by scrolling through a displayed listing. Users can lookup a transaction in block 266, accessible through block 248 that has been started in the sales center. Users can make modifications until the conclusion of the transaction has been confirmed by the back office or is dropped from the DMS.

Returning to FIG. 5, a client signing up with the company to use the system will enter detailed information about users (block 268). Namely, the users will include who will be accessing the system along with who will or will not be appraisers. This request will be sent to the system which will assign a user ID and password. A generic FAQ sheet will address, in block 270, most common questions about giving DMS access information.

After vehicle validation (block 256), users can enter addition vehicle information at block 272, FIG. 6, including photo or verbal comments. A dealer can setup, in block 274, how many days may pass until a vehicle must be reappraised. This allows a manager to reactivate appraisal so that it can be printed (block 276).

Block 278 (FIG. 4) represents the wholesaler response to a dealer request and will be sent back to the requesting appraiser and saved in the wholesalers past appraisals. Users can add a vehicle manually to the system, in block 280, that has not been picked up by the DMS yet. The vehicle will ultimately be picked up when processing the DMS.

In block 282, a dealership can enter a purchase amount, trade value, unit cost, outstanding and/or promised repairs, and gross profit, which computes a score (see block 284,) for the sale of a particular vehicle. The minimum information to be entered on this page is gross profit once a vehicle is designated/selected.

This page (block 286, FIG. 5) provides a client signing up to use the system with a set of instructions to follow once approved and all users associated with the client have been setup.

On this page (block 288, FIG. 6) co-appraisers and external wholesalers are sent a message notifying them that a vehicle is ready for their input after the vehicle to be appraised information has been entered (block 272). A printed appraisal should accompany every appraisal as a normal part of dealer practice (block 276, which is the same as block 170). A dealership salesman is allowed to print or reprint an appraisal as long as it is current. If an appraisal is old (dealer defined) a dealership manager can renew, which allows the appraisal to be reprinted.

A sales score is calculated (block 284, FIG. 4) based on a combination of dealer objectives, gross profit, and current market information and displayed for the manager.

Once a potential client has completed the signup process, the system will generate user identification codes (numbers or alphanumeric codes and passwords) at block 290, FIG. 5. The system should notify vendor to begin DMS extraction for the dealer.

This page (FIG. 6, block 292) displays the information about the vehicle being appraised based on a dealership region and selected subscriptions. Comments and/or appraisal amounts can be entered by the co-appraiser to assist in vehicle valuation (block 294). Once a sales score has been calculated (284), the information entered can be saved and retrieved later (block 296). Only the most current deal for a particular vehicle will be saved. Changing information on the sales detail screen (block 282) will allow a user to recalculate the score of the transaction (block 298). A user can also enter a desired score and the system can roll back and display a calculated gross profit.

Data regarding the sales transaction (block 300) will be sent to the scoreboard (one or both of blocks 146, 148) and counted in the units sold during the current day. The additional information screen (block 302) is used to enter details a dealership may wish to have displayed. The entry of additional information to accompany a vehicle sale in the sales log might include additional information such as deposit amount and/or date, whether the transaction involves finance or cash, spot; trade (Y/N), and responsible salesperson.

Block 304 (FIG. 6) shows supporting vehicles that make up the average amounts shown to the appraiser. An important option of the system and method of the present invention is the ability to factor in any vehicle incentives and or dealership alerts that have been setup. Incentives and other short term sales and offers, which may impact the value of a vehicle, are processed and/or displayed (block 306).

The response from the co-appraiser is processed and sent to the primary or original appraiser (block 308). The appraiser can view the response at block 310. An appraiser may quickly see similar inventory based on the category of vehicle being appraised (block 312).

An appraiser may also see similar inventory that was sold based on the category is of vehicle being appraised (block 314). The gross profit will be displayed if it was entered into the system. This information may not be available on the first day a dealer goes live, but, instead tends to build over time.

In block 316 the appraiser enters the dollar amount they want associated with an appraised vehicle. A score is assigned to a vehicle based on the appraisal amount, current market value and dealership objectives (block 318).

Once a manager accepts an appraisal (block 320), he or she “owns” the appraisal and holds responsibility therefor. This is intended to be used for accountability. If needed, any score threshold notifications would be sent out at this time. Changing information on the appraisal screen will allow a user to recalculate the score of the transaction (block 322). A user can also enter a desired score or a desired omega and the system can roll back into the gross profit. The appraiser can save the information they have gathered and have the ability to come back to it (block 324).

The Metric Calculations

### Background

The system and method of the present invention uses one or more of two formulaic expressions or metrics to measure and benchmark decisions of acquisition, stocking and dispositions. The first of these formulaic expressions is called the “omega” metric and the second is called the “performance score” metric. Examples and definitions of both of these metrics are provided hereinbelow.

In operation, a used vehicle department/operation buys, stocks, and sells vehicles. Vehicles are purchased in several ways, including trade-in acquisitions, wholesale acquisitions from auctions and wholesalers and occasionally outright purchases from private individual sellers. Vehicle inventory is also sold in several different ways. The most common methods are retail sales to consumers and wholesale sales to other sellers through auctions or by direct sales transactions. The optimal objective of a dealer is to purchase vehicles at or below current wholesale prices and then to sell them at or above current retail prices. Ideally the time in between these transactions should be as short as possible.

In reality, some vehicles that are acquired as trade-ins are not suitable to be sold at retail from the dealer's retail establishment. In such cases, a determination is made at a time close to the point of acquisition and selected cars are sold wholesale to another seller. Such transactions are called wholesale sales. Therefore a dealer's used vehicle sales are typically comprised of both retail and wholesale transactions.

### Establishing Baseline and Target Omega Metrics

The system and method of the present invention requires data input from the dealership user during the setup process to determine their existing or baseline omega metric. This baseline omega metric is calculated or derived by dividing the dealership's average vehicle unit sales gross profit by the percentage of water in inventory. Thus:
(Baseline) Omega Factor=Avg. vehicle GP/% inventory water

### Average Vehicle Gross Profit (Numerator)

Average gross profit is defined as the total used vehicle unit sales minus total sold used vehicle unit costs divided by the number of used vehicle sales transactions. For the purpose of calculating the baseline omega metric numerator it is preferred that the dealer perform the above calculation including both retail and wholesale transactions over the past twelve month period.

The following example illustrates a dealership having sold six vehicles over the past twelve months as follows.

| Sales in $ | Unit Cost in $ | Wholesale/Retail |
|---|---|---|
| 10,000 | 8,000 | R |
| 6,500 | 7,000 | R |
| 18,000 | 18,000 | R |
| 11,000 | 12,000 | W |
| 8,000 | 8,000 | W |
| 9,500 | 9,250 | W |

Total sales = $63,000
Total Unit Costs = $62,250
Total GP = $750 (63,000 − 62,250)
Avg. GP = $125 (750 dollars/6 units)

### Water (Denominator)

“Water” is a term in the automotive industry that refers to the difference between a vehicle or a portfolio of vehicles investment cost compared to their current wholesale values where the difference is a negative value. For example, a dealership may have $10,000 invested in a vehicle where its current wholesale value is $8,000. It is said that this vehicle has water of $2,000. Sometimes this water is expressed as a percentage such as 20 percent or 0.20. The same calculation principle as set out above can be applied to a portfolio of vehicles. In such a case, the total investment cost of all vehicles is divided by the total current market value for those vehicles. The percentage expression is the denominator of the omega calculation.

The following example illustrates a hypothetical current inventory of ten vehicles.

| | Current Market | | |
|---|---|---|---|
| Dealer Investment | Value | Water in dollars | Water Percentage |
| 10,000 | 9,500 | 500 | 5 |
| 11,000 | 11,250 | −250 | −2.27 |
| 9,500 | 9,500 | 0 | 0 |
| 10,500 | 10,000 | 500 | 4.76 |
| 13,000 | 12,500 | 500 | 3.85 |
| 16,000 | 16,250 | −250 | −1.56 |
| 14,000 | 13,000 | 1000 | 7.14 |
| 13,500 | 13,250 | 250 | 1.85 |
| 13,750 | 13,250 | 500 | 3.64 |
| 14,750 | 14,750 | 0 | 0 |

Total Dealer Investment = $126,000
Total Current Market Value = $123,250
Total water in dollars = $2,750
Total water percent = 2.18 percent (or .0218)

With both the numerator and denominator defined, the dealer's baseline omega can be determined by dividing $125/0.0218=5734. The system will perform this calculation once the dealer user has entered the requested required information related to past sales and existing inventory.

Next, the dealership user is prompted to enter a desired average vehicle sales gross profit and a maximum target water percentage. Once entered, the system will calculate the dealerships target omega.

On an ongoing basis, the system will automatically update the dealerships current omega. This is done by collecting finalized sales transaction information and by comparing present inventory investment cost with current market value. It is therefore possible for a dealership at any time to determine a current omega and its relationship to a baseline and a target omega metric. As will be described below, the dealership decision maker will also be able to determine the impact on the omega score of any proposed acquisition or disposition decision.

Before moving on to a detailed description of how the impact of omega and performance score will be calculated, there are two points to be noted. First, the dealership may change its target omega numerator or denominator at any time. This will cause the target omega to change. Previous calculations will need to be adjusted for such a change and others will need to be locked or frozen based on the then current target omega. For example historical omega and performance scores for acquisitions and dispositions should be frozen (stored) in order to track performance at a particular point in time. Conversely present inventory scores should be updated based on the new dealership objectives.

The second point to be noted is that the above description is how the omega will be calculated during the initial set up of the system. It will be understood that a metric such as the omega described above may be calculated a number of ways and that other metrics may also be applied to the system and method of the present invention. One modification contemplated is calculating a separate omega for retail and wholesale transactions. A preferred embodiment is to initially combine wholesale and retail sales transactions into a single omega metric.

### Performance Score Background

In addition to the omega calculation and the impact thereof, it is preferred to provide decision makers with another reference point to help guide the decision making process. In a preferred embodiment, there are three types of decisions that will generate a performance score. Like the omega calculation, the performance score includes and will be preferably based on a calculation including all acquisitions and dispositions. In addition to these two categories of decisions, the performance score will also be applied to stocking decisions. Unlike acquisition and disposition decisions which are affirmative in their nature i.e., either to buy or not to buy or to sell or not to sell, stocking decisions may be more implicit. For example, each day that a vehicle resides in inventory is equivalent to a decision to not sell the vehicle. It is well known that a very liquid wholesale market exists such that a dealer can wholesale any vehicle on any day if willing to accept the current market value for the given vehicle. Therefore, a performance score is tied to each vehicle in stock as if a decision was affirmatively made to keep the vehicle for another day. The following describes how the performance formula and omega impact are calculated and applied to each of three decision categories.

### Calculation and Application of Performance Scores and Omega Impact Acquisition Performance Score

The formula for determining the acquisition performance score is preferably as follows:
=(100*(1−(((Dealer vehicle Investment−vehicle Current market)/Dealer vehicle Investment)*Water Investment Weight))
−(((Dealer vehicle Investment−vehicle Current market)/1000)*Water dollar Weight))
−((Target Retail Gross Profit/Present Gross Profit)*Gross Profit Weight)

Note that the variable above described as target retail average gross profit is a variable that is initially determined by the dealership during the setup process. This variable may be changed by the dealership at any time consistent with current strategy. Note that it differs from the target average gross profit (numerator) of the above described target omega calculation to the extent that it excludes wholesale transactions. For example, it may be assumed that the dealership has expressed the desire to attain a target retail average gross profit of $2000 while currently having a present gross profit of $1750.

To illustrate the application of this formula, an example is provided wherein a used vehicle department manager is considering the acquisition of a vehicle where the systems third party data source determines the current market value to be $15,000. The department manager is considering valuing the vehicle slightly higher at $15,500 as a result of competitive pressure. In this example, the system will calculate the acquisition performance score as follows. Using the following assumptions for this dealer:
Water Investment Weight=0.9
Water Dollar Weight=5
Gross Profit Weight=5
Performance Score=(100*(1−(((15500−15000)/15500)*0.9))−(((15500−15000)/1000)*5))−((2000/1750)*5)
Performance Score=88.88

Note that the system will provide the user with a rollback feature that allows for the calculation of a suggested acquisition price based on a designated acquisition score. This rollback feature uses the same formula but solves for acquisition price rather than score. The formula for determining the acquisition price from performance score is preferably as follows:
A=1
B=(−200*(desired performance score)+2000+(current market value)−1000(Target gross profit/Current gross Profit))
C=(−18000)(Current market value)
(B+sqrt(bˆ2−(4*A*C)))/2
Or
((−200*(desired performance score)+2000+(current market value)−1000(Target gross profit/Current gross Profit))+sqrt(((−200*(desired performance score)+2000+(current market value)−1000(Target gross profit/Current gross Profit)))ˆ2+4(18000)(cmv)))/2

### Omega Impact

The calculation of the impact of the omega metric is derived by determining the difference between the dealerships current omega score and the revised omega score assuming the proposed acquisition. For illustration purposes, assuming that the current omega metric is equivalent to the previously described baseline of 5734 ($125/0.0218), the system will calculate the impact of the omega metric by determining the dealerships new omega assuming the proposed acquisition as follows:
Total Dealer Investment=$126,000+15,500=141,500
Total Current Market Value=$123,250+15,000=138,250
Total water in dollars=$2,750+500=3,250
NEW total water percent=2.30 or 0.0230
NEW omega metric=125/0.0230=5435
Or a negative impact of 299.

Note that the impact of the new omega metric may be expressed as a negative or positive absolute number. However, in an alternate embodiment, the impact may be expressed as a negative or positive percentage. Also the system will provide the user a similar rollback feature as described above for the performance score calculation. The formula for determining the acquisition price from a desired Omega Impact is preferably as follows:
Appraisal Amount=(−(Total Dealership water dollars)*(Desired Omega Impact)−(Total Dealership water dollars)*(Current Retail avg Gross Profit)/(Dealership Water percentage)+(Desired Omega Impact)*(Current Market Value)+(Current Market Value)*(Current Retail avg Gross Profit)/(Dealership Water percentage)+(Total Dealership Used vehicle investment amount)*(Current Retail avg Gross Profit))/(Desired Omega Impact)+(Current Retail avg Gross Profit)/(Dealership Water percentage)−(Current Retail avg Gross Profit)

### Stocking

In order to understand the application of the inventory performance score the score may be calculated for this vehicle both 30 and 60 days later, assuming that the current market values have fallen to $14,400 and $13,800 respectively. The exact same performance score formula as described above will be used to determine inventory performance scores on a daily basis as follows:

30 Days:
Inventory Score=(100*(1−(((15500−14400)/15500)*0.9))−(((15500−15000)/1000)*5))−((2000/1750)*5)
Inventory Score=82.39

60 Days:
Inventory Score=(100*(1−(((15500−13800)/15500)*0.9))−(((15500−15000)/1000)*5))−((2000/1750)*5)
Inventory Score=75.91

Note that there is no omega impact score for the stocking of vehicles although this is contemplated by the present invention in alternate embodiments.

### Disposition

To illustrate the calculation and application of the sales/disposition score assume that on the 61^{st} day the manager is considering a sale of this vehicle for $15,250. The formula is preferably as follows:
Sales Score=((Gross Profit/(2*target retail average gross profit))*35)+(65*(Dealer Investment/Current market value))
Sales Score=((−250/(2*2000))*35)+(65*(15500/13800))
Sales Score=70.82

Note that the system will provide the user with a rollback feature that allows for the calculation of a suggested disposition price based on a designated disposition score. This rollback feature may use the same formula but solves for disposition price rather than score.

### Omega Impact

The calculation of omega impact is derived by determining the difference between the dealerships current omega score and the revised omega score assuming the proposed disposition. As will be shown below, the calculation of omega impact for disposition will be derived by determining the difference in the dealerships omega factor before and after the transaction, but the disposition omega impact score requires a recalculation of both the numerator and denominator of the revised omega factor. In one example, for illustration purposes, it may be assumed that the current omega factor is equivalent to the previously described modified omega score of 5435. The system will calculate the omega impact by determining the dealerships new omega metric assuming the proposed disposition as follows.
Total Dealer Investment=$141,500−15,500=$126,000
Total Current Market Value=$138,250−13,800=$124,450
Total water in dollars=$1,550
NEW Total water percent=1.23 percent or 0.0123
Total sales=$63,000+15250=$78,250
Total Unit Costs=$62,250+15500=$77,750
Total GP=$500
Avg. GP=$71(500 dollars/7 units)

New average GP is $71
New omega factor=71/0.0230=3086
Or a negative impact of 2348.

Note that the omega impact is expressed as a negative or positive absolute number. However, in an alternate embodiment, one may choose to express the impact as a negative or positive percentage impact. Also, the system will provide the user a similar rollback feature as described above for the performance score calculation.

Please note that the above exemplary calculations are based on a non-representative sample of data and consequently the scale of the omega impact is considerably unrepresentative of expected results. The calculations, however, are shown according to examples of preferred embodiments of the invention and accurately represent the application of the principles of the invention.

### EXAMPLES

The following illustration provides a hypothetical example of how the present invention will achieve results according to the prescribed methodology.

In this hypothetical illustration a dealership has preconfigured objectives as follows:

| | |
|---|---|
| Target Inventory | $1,000,000 |
| Target Average Unit Gross Profit Retail | 2,000 |
| Target Average Unit Gross Profit Wholesale | 0 |
| Standard Markup | 4,000 |
| Average Monthly Unit Volume over past 12 months - | 40 |
| Retail | |
| Average Monthly Unit Volume over past 12 months - | 50 |
| Wholesale | |
| Average Unit Gross Profit over past 12 months - | 1,500 |
| Retail | |
| Average Unit Gross Profit over past 12 months - | −100 |
| Wholesale | |
| Target Average Unit Age | 60 Days |
| Max acceptable water | 15% |

The system will prompt dealership users to maintain the above referenced variables in their system. Any and or all of the variables can be modified from time to time by users with appropriate user authorization.

Continuing this hypothetical example, assume that a perspective customer brings their 2002 Dodge Durango to the dealership as a trade in to be applied against the purchase price of a new vehicle acquisition. Using the invention, a salesperson would enter the required customer and vehicle information pertaining to the trade in. Once complete, the sales person will choose which appraiser (or appraisers) should be notified to conduct the appraisal process. Once selected, the system will page the appropriate appraiser(s) via a wireless message. The responding appraiser using a mobile device will log into the system and find the vehicle information pertaining to the pending appraisal vehicle.

Upon visual inspection the appraiser will validate the previously entered vehicle information and or make any necessary modifications using a wireless device. The appraiser will have the option of recording a voice message about the vehicle and or capturing an image(s) of the vehicle using digital imaging technology. Once the vehicle validation process including the above referenced steps is complete the invention will notify preconfigured internal and or external co-appraisers/wholesalers using wireless messaging technology. Once notified, the co-appraisers can view on a mobile and or desktop device the relevant vehicle information captured in the previously described vehicle validation process. This includes viewing and listening to images and or voice comments.

The co-appraisers can respond using a desktop or mobile device with their appraisal amount along with text comments. While the appraiser is receiving input from the co-appraisers he/she can review listings of similar vehicles in inventory or past sales. Additionally, the appraiser can receive notification of recently announced manufacturer incentives on similar new like make and model vehicles. This is valuable because the used vehicle valuation impact of such recently announced incentives may not yet be known to the appraiser, co-appraiser or valuation guide services. Additionally, the appraiser can receive dealership alert notices that may impact the appraiser's valuation decision for the vehicle in question. For example when evaluating a 2002 Dodge Durango a message alert may appear warning the appraiser to be mindful of the possibility of a characteristic transmission problem. All of the above data inputs may be received on either a desktop or wireless handheld mobile device.

The third step in the appraisal method of the present invention is collection and display of third party valuation information including but not limited to data from valuation guides, auctions, internal co-appraisers, and or external wholesaler co-appraisers. For illustration purposes assume that the following valuations are returned:

| | |
|---|---|
| Black Book | $19,500 |
| NADA | $20,250 |
| Auction | $18,900 |
| Co-appraiser 1 | $20,000 |
| Co-appraiser 2 | $19,750 |

Any or all of the above information can be captured and displayed using both desktop and or wireless mobile devices. In this hypothetical example Black Book will be considered the dealership's primary valuation guide and the dealership presently has 10 percent water in its inventory.

The next step is for the appraiser to enter a proposed appraisal value in light of the previously described data points. The entry of the proposed value can be done using either a desktop and or wireless mobile device. In this illustration, assume that the appraisers proposed entered value is $20,000 dollars. The present invention will formulaically compare the proposed value of $20,000 dollars with the previously established dealership objectives and produce a display of purchase performance and Omega impact scores. These scores will be derived as follows:

### Purchase Performance

=(100*(1−(((Dealer vehicle Investment−vehicle Current market)/Dealer vehicle Investment)*Water Investment Weight))
−(((Dealer vehicle Investment−vehicle Current market)/1000)*Water dollar Weight))−((Target Gross Profit/Present Gross Profit)*Gross Profit Weight)
or
Purchase Performance Score=(100*(1−(((20000−19500)/20000)*0.9))−(((20000−19500)/1000)*5))−((2000/1500)*5)
Purchase Performance Score=88.58

### Omega Impact

Omega Factor=Avg. vehicle GP/% inventory water

Omega impact is the difference between the Omega Factor before the purchase and the Omega Factor after the purchase.
Omega Factor (before)=1500/0.10=15000

### After Purchase

Current market of present inventory=900,000+19,500=$919,500
Current investment amount of inventory=1,000,000+20,000=$1,020,000
Resulting in a new water percentage of 1020000−(X*1020000)=919500

Solving for X we get a new water percentage of 9.85 percent.
Omega Factor (after)=1500/0.0985=15228
The Omega impact is: +228 (15228−15000)

The appraiser is now able to either accept or modify the previously entered proposed evaluation amount.

The appraiser also has the option to derive a valuation based on a target acquisition score or omega impact score. For example, if the appraiser wanted to achieve a certain performance score or omega score, he/she would enter the target value into the invention's rollback feature function and the system would automatically calculate the appropriate valuation amount. For example, if the appraiser wanted a score of 92 the valuation amount would be based on the purchase score formula from above.

### Purchase Score Rollback

92=100(100*(1−(((X−19500)/20000)*0.9))−(((X−19500)/1000)*5))−((2000/1500)*5)

Solving for X yields a valuation of: 19625

### Omega Score Rollback

If the appraiser wanted an Omega impact of 250 (instead of the 228) the calculation would be as follows:
15250=1500/X

Solving for X yields 0.09836

Continuing through the calculation:
1000000+X−(0.09836*(1000000+X))=919500
Solving for X yields a valuation of 19808 is needed.

Once the appraiser is satisfied with an appropriate appraisal amount, he/she will designate an amount as final and the system will permanently record the valuation amount along with all of the previously described data. Assuming that the dealership completes the transaction that involves the trade in question, the trade in vehicle will become part of the dealerships stock inventory. Each day that the vehicle is in inventory the present invention will compare the vehicles current investment amount and present market value. The following formula will produce an inventory performance score.
Inventory Performance Score=
=(100*(1−(((Dealer vehicle Investment−vehicle Current market)/Dealer vehicle Investment)*Water Investment Weight))
−(((Dealer vehicle Investment−vehicle Current market)/1000)*Water dollar Weight))−((Target Gross Profit/Present Gross Profit)*Gross Profit Weight)

Every day dealership management has the ability to compare relative inventory scores for all stock vehicles. Those vehicles displaying the lowest scores represent the portion of inventory that is most at risk from an investment perspective. This allows management a quick and easy method of identifying those vehicles that are in most need of immediate disposition through either retail or wholesale means. The display of inventory performance scores can be viewed through desktop computers and/or wireless mobile devices. Further the present invention allows users to receive proactive message notifications on both desktop computers and wireless mobile devices alerting them to inventory conditions that exceed predetermined thresholds.

For example the acquisition of the hypothetical vehicle in question may cause the dealerships aggregate inventory investment to exceed the 1,000,000 dollar objective level. This condition may trigger a notification to the appropriate manager of the out of line condition. Similar notifications include proactive messages for other variables including various scoreboard-listed data, e.g., pending appraisals, completed appraisals, average completed appraisal score, used vehicles sold, used vehicle average gross profit, used vehicle total gross profit, average daily sales score, new vehicles sold, average gross profit, total gross profit, wholesale units sold, wholesale average gross profit, wholesale total gross profit, average daily wholesale sales score, used vehicle inventory investment, average cost, average days in stock, average inventory score, water in dollars, percent water, turn, average retail gross profits, water, omega and ROI.

Ultimately every vehicle in dealership inventory will have either a retail or wholesale disposition sale. The present invention allows dealership management to assess the extent to which the sale of any vehicle comports with the dealerships stated objectives. Continuing the example, suppose that the hypothetical 2002 Dodge Durango had a present inventory investment of $20,250 dollars (including the original acquisition cost and associated maintenance and repair). Further suppose that a dealership manager was considering an offer for either retail or wholesale disposition for an amount of $21,500 dollars. In such a case the selling manager could enter details of the proposed transaction, minimally including gross profit. In this case the gross profit is the difference between the proposed selling price and the dealerships investment cost or $1,250 dollars (21,500−20,250). The present invention will formulaically analyze by comparing the proposed gross profit to the stated dealership objectives and produce a sales performance score and Omega impact score as follows(assuming same current market value of $19,500):

### Sales Performance Score

Sales Score=((Gross Profit/(2*target retail average gross profit))*35)+(65*(Dealer Investment/Current market value))
Or
Sales Score=((1250/(2*2000)*35)+(65*(20250/19500))

Sales Score=78.43

Omega Impact Score

The sale of a vehicle impacts both the gross profit and water percentage components of the Omega equation.

Omega Factor (before)=15228

### After Disposition

Current market of present inventory=919500−19500=900,000
Current investment amount of inventory=$1,020,000−20000=1,000,000
Resulting in a new water percentage of 1000000−(X*1000000)=900000

Solving for X we get a new water percentage of 10.00 percent.

A new average gross profit will need to be calculated (assuming only this transaction) the new average would be:
($1500*40 units+$1250)/41 units=1494
Omega Factor (after)=1494/0.10=14940
The Omega impact is: −288(15228−14940)

The sales performance score of X and or the Omega impact score of Y provides the selling manager with objective metrics. These metrics determine the extent to which the vehicle's proposed sale support the dealership's predetermined financial objectives. As described above the selling manager also has the ability to use a rollback feature function to derive a desired selling amount from a predetermined target sales performance score and or Omega impact score.

For example, if the dealership manager wanted to know the necessary sales price to achieve a sales performance score of 85 and or an Omega impact score of +100, he/she would enter those respective target values into the invention's rollback sales feature function. The respective calculations and results would be derived as follows:

### Score Rollback

85=((X−20250/(2*2000)*35)+(65*(20250/19500))

Solving for X yields a sales price of 22250.

### Omega Rollback

+100 omega means that a dealership would need an after Omega factor of 15328
15328=X/0.10

Solving for X yields 1532.8 which continuing with the rollback would give:
1532.8=($1500*40 units+X)/41 units

Solving for X yields $2845 gross profit is needed which results in a sales price of:
$23,095 (20,250 Current investment+2845 Gross Profit)

Once the selling manager determines the appropriate selling price and finalizes this transaction the present invention will automatically send appropriate details to a virtual sales transaction log. This sales transaction log is accessible to all users with appropriate authority through a desktop computer or wireless mobile device. Further, users of the invention can request proactive notification whenever a completed transaction is recorded in the sold transaction log. Permanent records of each detailed sales transaction are created and maintained in order to insure visibility and accountability for all sales transactions and their respective decision makers.

It is understood that some dealerships may choose not to use the above described sales functionality. In such cases the present invention allows for an administrative person to enter sales transaction details after the fact. Alternatively the same information may be entered into the system through an electronic interface with the dealerships management system. In either case, the present invention will allow the capture and maintenance of detailed and or aggregate month to date sales transaction information.

The preceding functionality is not designed or intended to replace the judgment experience or discretion of key individual decision makers. Rather this invention is designed to provide a common objective framework or construct to assist decision makers in achieving departmental objectives. Furthermore, the specific numeric scores generated by the specific expressions given herein are exemplary in nature and should not be considered the only embodiments of the invention or limiting.

While the apparatus and method herein disclosed forms a preferred embodiment of this invention, this invention is not limited to that specific apparatus and method, and changes can be made therein without departing from the scope of this invention, which is defined in the appended claims.

What is claimed is:

1. A method for a seller of used vehicles to evaluate the acquisition of at least one used vehicle for subsequent sale, comprising the steps of:
determining an initial water value, said initial water value based on a seller's inventory;
determining an initial average gross profit;
calculating an initial metric, said initial metric based on a relationship between said initial average gross profit and said initial water value;
formulating an appraisal value for the acquisition of said at least one used vehicle;
determining a revised water value, said revised water value based on a seller's inventory, which includes the at least one used vehicle;
calculating a proposed metric, said proposed metric based on a relationship between said average gross profit and said revised water value; and
comparing said initial metric to said proposed metric to evaluate the acquisition of said at least one used vehicle.

2. The method for a seller of used vehicles to evaluate the acquisition of at least one used vehicle for subsequent sale in claim 1, wherein said determining an initial water value comprises calculating the difference between the cost and the wholesale value of said at least one used vehicle.

3. The method for a seller of used vehicles to evaluate the acquisition of at least one used vehicle for subsequent sale in claim 2, wherein said cost is the total investment that the seller has made for a particular inventory.

4. The method for a seller of used vehicles to evaluate the acquisition of at least one used vehicle for subsequent sale in claim 1, wherein said determining an initial water value comprises calculating the percentage of the cost of said at least one used vehicle to the wholesale value of said at least one used vehicle.

5. The method for a seller of used vehicles to evaluate the acquisition of at least one used vehicle for subsequent sale in claim 1, wherein said determining an initial average gross profit comprises calculating the average difference between a sales amount and a cost of seller's inventory for those sales over a period of time.

6. The method for a seller of used vehicles to evaluate the acquisition of at least one used vehicle for subsequent sale in claim 5, wherein said period of time is 12 months.

7. The method for a seller of used vehicles to evaluate the acquisition of at least one used vehicle for subsequent sale in claim 5, wherein said calculating an initial metric comprises dividing said initial average gross profit by said initial water value.

8. The method for a seller of used vehicles to evaluate the acquisition of at least one used vehicle for subsequent sale in claim 1, wherein said formulating an appraisal value for said at least one used vehicle comprises a first appraiser calculating an appraisal for said at least one used vehicle based on the type of vehicle and the condition of said vehicle.

9. The method for a seller of used vehicles to evaluate the acquisition of at least one used vehicle for subsequent sale in claim 1, wherein said formulating an appraisal value for said at least one used vehicle comprises a co-appraiser calculating an appraisal for said at least one used vehicle based on the type of vehicle and the condition of said vehicle.

10. The method for a seller of used vehicles to evaluate the acquisition of at least one used vehicle for subsequent sale in claim 1, wherein said formulating an appraisal value for said at least one used vehicle comprises a co-appraiser calculating an appraisal for said at least one used vehicle based on the type of vehicle, the condition of said vehicle, and a third party data source.

11. The method for a seller of used vehicles to evaluate the acquisition of at least one used vehicle for subsequent sale in claim 10, wherein said third party data source comprises estimates for the at least one used vehicle selected from the group consisting of Black Book, Kelly Blue Book, Galves, NADA and auction prices.

12. The method for a seller of used vehicles to evaluate the acquisition of at least one used vehicle for subsequent sale in claim 1, wherein said determining a revised water value comprises calculating the percentage of the cost of said at least one used vehicle to the wholesale value of said at least one used vehicle, which includes the information from the at least one used vehicle.

13. The method for a seller of used vehicles to evaluate the acquisition of at least one used vehicle for subsequent sale in claim 1, wherein said period of time is 12 months.

14. The method for a seller of used vehicles to evaluate the acquisition of at least one used vehicle for subsequent sale in claim 1, wherein said calculating a proposed metric comprises dividing said revised average gross profit by said revised water value.

15. A method for evaluating a proposed acquisition of at least one used vehicle for subsequent sale, comprising the steps of:
determining a current metric, said current metric in part based on an inventory at the time of the proposed acquisition;
formulating an appraisal for the acquisition of said at least one used vehicle;
said appraisal based on at least the type of vehicle and the condition of the vehicle;
determining a proposed metric, said proposed metric in part based on the seller's inventory after the acquisition of the at least one used vehicle occurs;
determining the impact of the acquisition of the at least one used vehicle by subtracting the proposed metric from the current metric.

16. The method for evaluating the acquisition of at least one used vehicle in claim 15 wherein said determining the impact of the acquisition is performed at the time of the potential acquisition.

17. The method for evaluating the acquisition of at least one used vehicle in claim 15 wherein said determining the impact of the acquisition is performed again approximately 30 days after the time of the acquisition using a revised proposed metric.

18. The method for evaluating the acquisition of at least one used vehicle in claim 15 wherein said determining the impact of the acquisition is performed again approximately 60 days after the time of the acquisition using a revised proposed metric.

19. The method for evaluating the acquisition of at least one used vehicle in claim 15 wherein said determining a current metric comprises dividing an initial average gross profit by an initial water value.

20. The method for evaluating the acquisition of at least one used vehicle in claim 15 wherein said determining a proposed metric comprises dividing a revised average gross profit by a revised initial water value.

21. A method for determining a performance score relating to at least one used vehicles, comprising the steps of:
determining an acquisition performance score for said at least one vehicles based on vehicle cost, current market value, target gross profit, and present gross profit at a first date.

22. The method for determining a performance score of claim 21, wherein said determining an acquisition score comprises using the following expression:
(100*(1−(((dealer vehicle Investment−vehicle current market)/dealer vehicle investment)*water investment weight))−(((dealer vehicle investment−vehicle current market)/1000)*water dollar weight))−((target gross profit/present gross profit)*gross profit weight).

23. The method for determining a performance score of claim 22, further comprising the steps of:
formulating an appraisal amount for the at least one used vehicles;
comparing said acquisition performance score determined at said first date and a revised acquisition performance score assuming the transaction takes place according to the formulated appraisal.

24. The method for determining a performance score of claim 22, further comprising:
determining a second performance acquisition score at a second date, said second performance score based on vehicle cost, current market value, target gross profit, and present gross profit, said second date being later than said first date.

25. The method for determining a performance score of claim 24, wherein said determining a second performance acquisition score comprises using the following expression:
(100*(1−(((dealer vehicle Investment−vehicle current market)/dealer vehicle investment)*water investment weight))−(((dealer vehicle investment−vehicle current market)/1000)*water dollar weight))−((target gross profit/present gross profit)*gross profit weight).

26. The method for determining a performance score of claim 25, wherein said second date is approximately one day after said first date.

27. The method for determining a performance score of claim 26, wherein said at least one used vehicles is the entire inventory of vehicles.

28. The method for determining a performance score of claim 25, wherein said second date is approximately one week after said first date.

29. The method for determining a performance score of claim 25, wherein said second date is approximately one month after said first date.

30. A method of making a transaction related to a disposition of at least one used vehicles, comprising:
determining a sales performance score according to the expression:
((gross profit/(2*target retail average gross profit))*35)+(65*(dealer investment/current market value))
formulating a transaction including a disposition amount for the at least one used vehicles; and
comparing the sales performance score determined before the transaction and a revised sales performance score assuming the transaction takes place according to the formulated disposition amount.

31. A computerized used vehicle acquisition system including a program storage device readable by said computerized system, said program storage device including a program of instructions executable by said system to perform method steps for quantifying one or more business metrics, said method comprising:
a) maintaining a database of one or more business transactions;
b) calculating an average gross profit of the one or more business transactions;
c) calculating a water value in an inventory of items from the business transactions; and
d) calculating an initial metric.

32. The system of claim 31, further including executing the method steps of:
e) entering into said system a desired average sales gross profit;
f) entering into said system a maximum target water value; and
g) calculating a desired metric.

33. The system of claim 32, further including executing the method steps of:
h) collecting finalized sales information;
i) updating the database of one or more business transactions with the finalized sales information;
j) comparing present cost of the inventory with a current market value of the inventory;
k) calculating a current metric; and
l) comparing the current metric to one or both of the initial metric and the desired metric to determine the performance of a business or the desirability of a proposed business transaction.
